(19) United States
(12) Patent Application Publication
(10) Pub. No.: US 2025/0299220 A1
(43) Pub. Date: Sep. 25, 2025

(54) FRAMEWORK FOR SETTING UP SURVEY HIERARCHY AND AGGREGATION SCHEME FOR SUITE OF APPLICATIONS

(71) Applicant: SAP SE, Walldorf (DE)

(72) Inventors: Martin SCHREPP, Hockenheim (DE); Sandra LOOP, Waterloo (CA); Erik BERTRAM, Punkerstraße (DE); Sebastian JUHL, Hanstedt (DE); Nina HOLLENDER, Weinheim (DE); Ramandeep KAUR, Mannheim (DE); Stephanie RANGE, Dossenheim (DE); Carl DANNENHAUER, Mannheim (DE); Carmen PADURARU, Heidelberg (DE); Melanie HOLZAPFEL, Heidelberg (DE)

(21) Appl. No.: 18/612,165

(22) Filed: Mar. 21, 2024

(51) Int. Cl. G06Q 30/0242; G06Q 10/0639

(52) U.S. Cl. CPC G06Q 30/0245; G06Q 10/06393

(57) ABSTRACT

A system associated with a user experience survey framework for an enterprise may include an enterprise product hierarchy data store that contains information about a hierarchy of product nodes. Each product node may be, for example, associated with a user application. A computer processor of a user experience survey tool may receive from the enterprise an adjustment to the hierarchy of product nodes and store an adjusted hierarchy of product nodes into the enterprise product hierarchy data store. The user experience survey tool may then retrieve user experience survey results for a plurality of user applications. The retrieved user experience survey results are automatically aggregated in accordance with the adjusted enterprise product hierarchy and an aggregation rule selected by the enterprise. An indication of the aggregated user experience survey results may then be output to the enterprise.

### BACKGROUND

An enterprise may be interested in user experiences with respect to various products and applications. For example, user experience may be a substantial success factor for interactive products. Thus, continuous control of user experience quality may be important to avoid a loss of customers (and, thus, market share). Moreover, large enterprises may offer numerous different applications making this a difficult challenge. User experience quality might need to be reported with respect to different levels of a complex product hierarchy, and different aggregation methods may be needed to answer different types of research questions. In addition, the factors that are important for the overall user experience impression may differ between various products. That is, depending on the product it may be required to measure different user experience factors resulting in different KPIs (and asking different questions to application users). An additional difficulty may result from the fact that user experience is a highly subjective impression, different users might have different opinions and therefore user experience is often measured based on user groups. However, sampling effects may need to be considered when deciding if a change in user experience KPIs is meaningful (statistically significant) or just a result of random sampling effects. Still another challenge is that different channels may be used to collect feedback, for example, feedback buttons placed in the products, e-mail campaigns, or campaigns on social media channels. Thus, feedback can result from different surveys, and an enterprise may want to consolidate overlapping survey questions to an understand an overall picture of user experience.

Some survey platforms allow for the creation of arbitrary surveys, including surveys that measure user experience KPIs. These surveys can be sent over different channels to users and results can be visualized over dashboards. However, this only lets an enterprise measure single products. These survey platforms do not offer any integrated processes or suggestions concerning a concept and realization of product hierarchies and the automatic aggregation of KPIs along such hierarchies. In addition, there is no standardized and preconfigured best practice for user experience measurement (instead, these tools just offer general methods to set up arbitrary surveys).

Manually compilating and interpreting survey results can be a time consuming, difficult, and error prone task, especially when there are a large number of products, applications, survey channels, etc. It would therefore be desirable to provide a user experience survey tool within a user experience survey framework for an enterprise in a secure, automatic, and efficient manner.

### SUMMARY

According to some embodiments, methods and systems associated with a user experience survey framework for an enterprise may include an enterprise product hierarchy data store that contains information about a hierarchy of product nodes. Each product node is associated with a user application. A computer processor of a user experience survey tool may receive from the enterprise an adjustment to the hierarchy of product nodes and store an adjusted hierarchy of product nodes into the enterprise product hierarchy data store. The user experience survey tool may then retrieve user experience survey results for a plurality of user applications. The retrieved user experience survey results are automatically aggregated in accordance with the adjusted enterprise product hierarchy and an aggregation rule selected by the enterprise. An indication of the aggregated user experience survey results may then be output to the enterprise.

Some embodiments comprise: means for receiving, by a computer processor of a user experience survey tool from the enterprise, an adjustment to a hierarchy of product nodes; mean for storing an adjusted hierarchy of product nodes into the enterprise product hierarchy data store, wherein the enterprise product hierarchy data store contains information about the hierarchy of product nodes, each product node being associated with a user application; means for retrieving user experience survey results for a plurality of user applications; means for automatically aggregating the retrieved user experience survey results in accordance with the adjusted enterprise product hierarchy and an aggregation rule selected by the enterprise; and means for outputting to the enterprise an indication of the aggregated user experience survey results.

Some technical advantages of some embodiments disclosed herein are improved systems and methods to provide a user experience survey tool within a user experience survey framework for an enterprise in a secure, automatic, and efficient manner.

### BRIEF DESCRIPTION OF THE DRAWINGS

FIG. 1 is a high-level system architecture in accordance with some embodiments.

FIG. 2 is a method according to some embodiments.

FIG. 3 illustrates a product hierarchy in accordance with some embodiments.

FIGS. 4 through 15 illustrate a user interface for setting up a product hierarchy according to some embodiments.

FIG. 16 is a user survey tool method in accordance with some embodiments.

FIG. 17 is a user survey tool dashboard display according to some embodiments.

FIG. 18 is a user survey tool KPI display in accordance with some embodiments.

FIG. 19 is a user survey tool comments analysis display according to some embodiments.

FIG. 20 is a user survey tool architecture in accordance with some embodiments.

FIG. 21 is an apparatus or platform according to some embodiments.

FIG. 22 is a portion of a user experience data store in accordance with some embodiments.

FIG. 23 illustrates a tablet computer product hierarchy display according to some embodiments.

FIG. 24 is a user survey tool operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

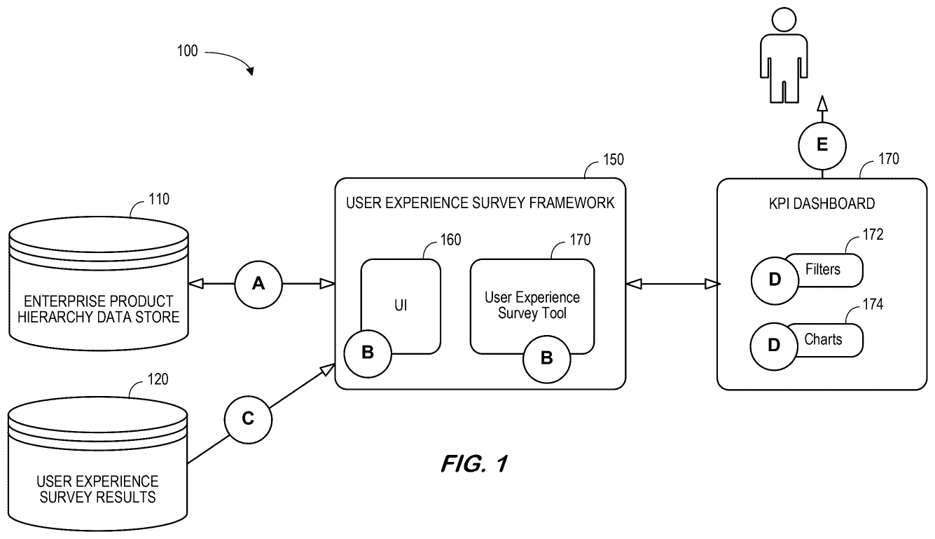

FIG. 1 is a high-level block diagram of one example of a system 100 architecture according to some embodiments. In particular, at (A), the user experience survey framework 150 accesses information about a hierarchy of product nodes (e.g., each product node being associated with a user application) form an enterprise product hierarchy data store 110. The user experience survey framework 150 may then use a User Interface (“UI”) 160 and user experience survey tool 160 at (B) to receive updates and/or adjustments to the hierarchy. At (C), the user experience survey framework 150 may receive user experience survey results 120. The system 100 may then automatically aggregate the retrieved user experience survey results 120 in accordance with the adjusted enterprise product hierarchy and an aggregation rule selected by the enterprise. At (D), a Key Performance Indicator (“KPI”) dashboard 170 may include filters 172 that can be used to generates charts 174 that are output to the enterprise at (E) (e.g., to improve product and/or application design and performance). As used herein, the term “KPI” may refer to any performance or user opinion such as those associated with quantitative data (e.g., with a specific objective numeric value) and/or qualitative data (e.g., representing non-numeric indications of personal feelings, tastes, opinions, experiences, etc.). According to some embodiments, a remote operator or administrator device may be used to configure or otherwise adjust the system 100.

As used herein, devices, including those associated with the system 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The user experience survey framework 150 may store information into and/or retrieve information from various data stores (e.g., the enterprise product hierarchy data store 110), which may be locally stored or reside remote from the user experience survey framework 150. Although a single user experience survey framework 150 is shown in FIG. 1, any number of such devices may be included. Moreover, various devices described herein might be combined according to embodiments of the present invention. For example, in some embodiments, the enterprise product hierarchy data store 110 and the user experience survey framework 150 might comprise a single apparatus. The system 100 functions may be performed by a constellation of networked apparatuses, such as in a distributed processing or cloud-based architecture. In some cases, the user experience survey framework 150 may process information associated with a number of different enterprises.

The enterprise may access the system 100 via a remote device (e.g., a Personal Computer (“PC”), tablet, or smartphone) to view information about and/or manage operational information in accordance with any of the embodiments described herein. In some cases, an interactive Graphical User Interface (“GUI”) display may let an operator or administrator define and/or adjust certain parameters via a remote device (e.g., to specify how the framework 150 connects with an enterprise computing environment infrastructure) and/or provide or receive automatically generated recommendations, alerts, summaries, or results associated with the system 100.

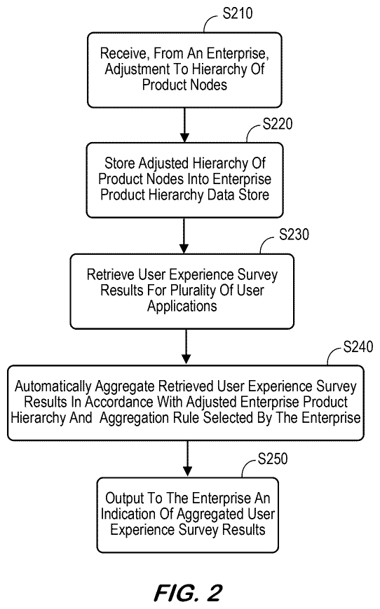

FIG. 2 is a method that might be performed by some or all of the elements of the system 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

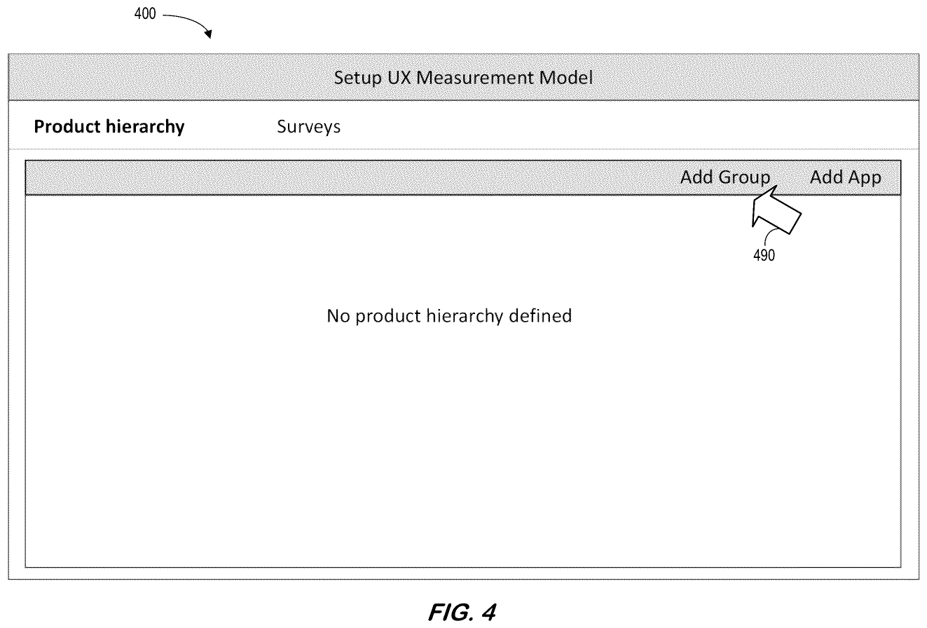

At S210, a computer processor of a user experience survey tool may receive, from an enterprise, an addition or adjustment to a hierarchy of product nodes (e.g., as described with respect to FIGS. 4 through 15). At S220, the system may store an adjusted hierarchy of product nodes into an enterprise product hierarchy data store. The enterprise product hierarchy data store may, for example, contain information about a hierarchy of product nodes, each product node being associated with a user application.

At S230, the system may retrieve user experience survey results for a plurality of user applications. The retrieved user experience survey results might be associated with, for example, existing standard user experience surveys that may be contained as templates, such as for Customer Satisfaction (“CSAT”) data, Net Promoter Score (“NPS”) data, Usability Metric for User Experience (“UMUX”) data, System Usability Scale (“SUS”) data, User Experience Questionnaire (“UEQ”) data, or customer defined surveys, such as for demographic information, a user role, a length of application use, etc. That is, an enterprise may define new metrics and/or use standardized questionnaires (which may be enhanced by the enterprise using the framework). According to some embodiments, the retrieved user experience survey results are associated with multiple channels, such as a product feedback channel, an e-mail campaign channel, a social media channel, etc.

At S240, the system may automatically aggregate the retrieved user experience survey results in accordance with the adjusted enterprise product hierarchy and an aggregation rule selected by the enterprise. For example, the automatic aggregation might be performed on the basis of single user experience survey answers, and thus each single response to a survey associated with a hierarchy node will have the same impact. As another example, the automatic aggregation may be performed on the basis of unweighted user experience survey results for all user applications below a particular node in the product hierarchy. In some embodiments, the automatic aggregation is instead performed on the basis of weighted user experience survey results for all user applications below a particular node, to take into account the fact that different applications have different levels of importance with respect to the overall goals of an enterprise.

At S250, the system may output to the enterprise an indication of the aggregated user experience survey results. The indication of the aggregated user experience survey results might include, for example, KPIs, confidence intervals, significance indicators, etc. According to some embodiments, the user experience survey tool may also automatically generate a user survey from a template library and/or receive a user experience survey defined by the enterprise. In some embodiments, the user experience survey tool is further to automatically generate a user experience survey link (e.g., so that users can access a survey via a web page). Moreover, the user experience survey tool may further automatically analyze open-ended user experience survey results using Artificial Intelligence (“AI”) algorithms to create a summary.

In this way, embodiments may define a framework to set up a measurement process that solves challenges in measuring user experience for a suite of products in an efficient way. The framework may consider and predefine important cornerstones of such a process letting an enterprise set up a state-of-the-art measurement process for a suite of applications with relatively little effort.

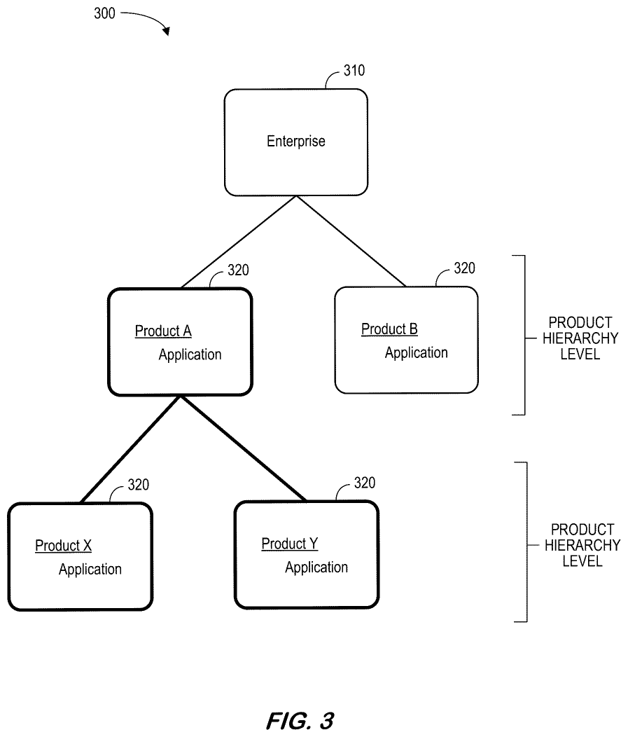

To begin setting up the process, an enterprise can define a product hierarchy by organizing applications in a tree structure of arbitrary depth. For example, FIG. 3 illustrates a product hierarchy 300 for an enterprise 310 in accordance with some embodiments. The hierarchy 300 includes product nodes 320, with each product node 320 being arranged in a product hierarchy level and associated with a user application. The product nodes 320 represent the organizational structure (or, more generally, the structure used for survey result aggregations) with leaves in the hierarchy 300 representing applications. In some cases, an application may be assigned to exactly one product node 320, but it is also possible to assign a single application to multiple product nodes 320. The hierarchy 300 can be changed or adjusted by the enterprise at any point in time. According to some embodiments, an aggregation rule defined for a product node 320 may be automatically applied to child product nodes 320 in the hierarchy 300. For example, an aggregation rule assigned to “Product A” may be automatically applied to “Product X” and “Product Y” (as illustrated by bold lines in FIG. 3) but not to “Product B.”

FIGS. 4 through 15 illustrate a user interface for setting up such a product hierarchy 300 according to some embodiments. The example in these FIGS. refers to “CoolBikes,” a manufacturer of bicycles and corresponding accessories. The enterprise offers classic bicycles, e-bikes, and some accessories. The bicycles are sold via two web-shops, one for classic bicycles and one for e-bikes. In addition, the enterprise has a product configurator that lets customers configure certain elements (e.g., item color and optional parts). In addition, CoolBikes runs several marketing web-sites and a company home page. To manage their internal processes, they have developed several applications and dashboards. In order to remain competitive, the enterprise wants to establish a process for user experience measurement.

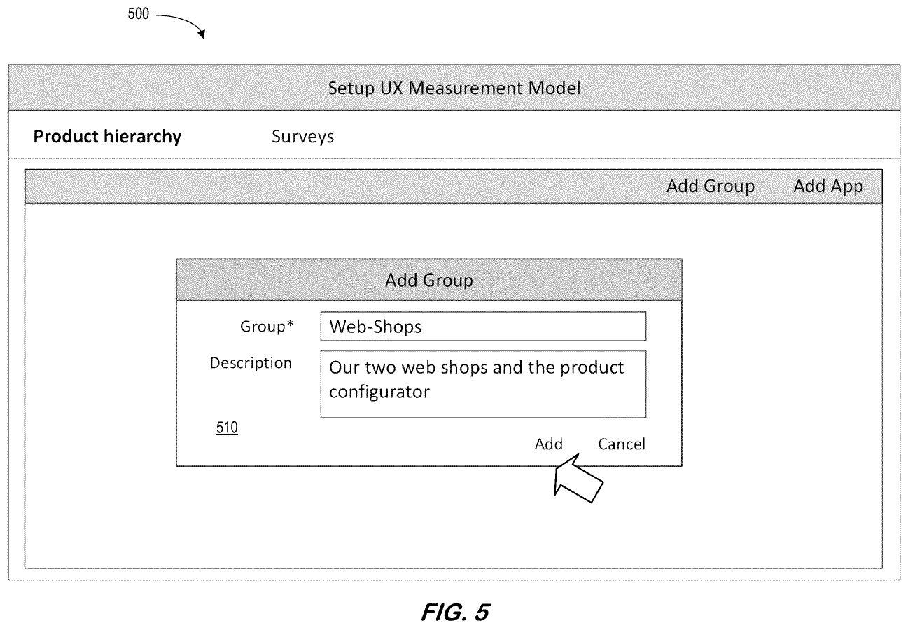

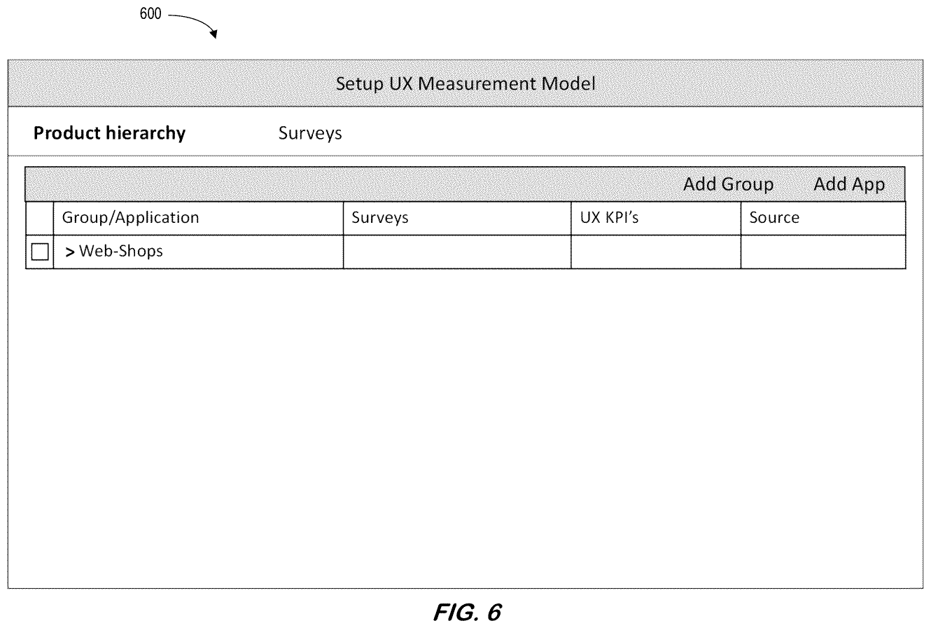

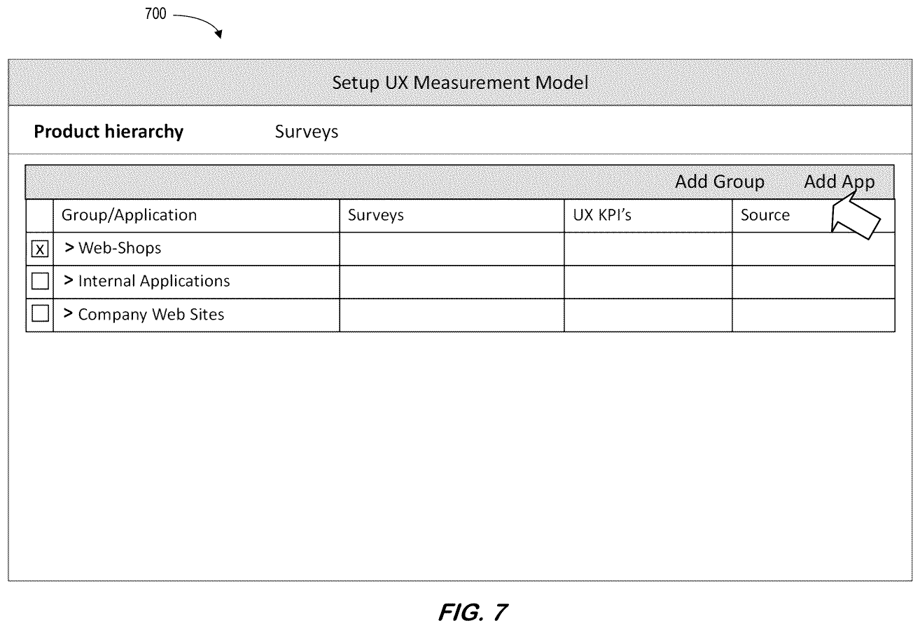

Initially, an administration enters a configuration screen of a user experience measurement service and defines a product hierarchy. For example, FIG. 4 shows a setup interface 400 of a user experience measurement service before a product hierarchy is defined. The administrator may then use a touchscreen or computer mouse pointer 490 to select and “Add Group” icon. FIG. 5 shows an interface 500 with an add group data entry area 510 that may be used to provide a group name, a group description, etc. When an “Add” icon is selected, a table is updated with the new group (“Web-Shops”) as in the table shown in the example interface 600 of FIG. 6. Each entry now in the table is associated with a hierarchy node and may include a group (product) or application name, associated surveys, user experience KPIs, information sources, etc. This process may be repeated to add groups for “Internal Applications” and “Company Web Sites” as shown in the interface 700 of FIG. 7.

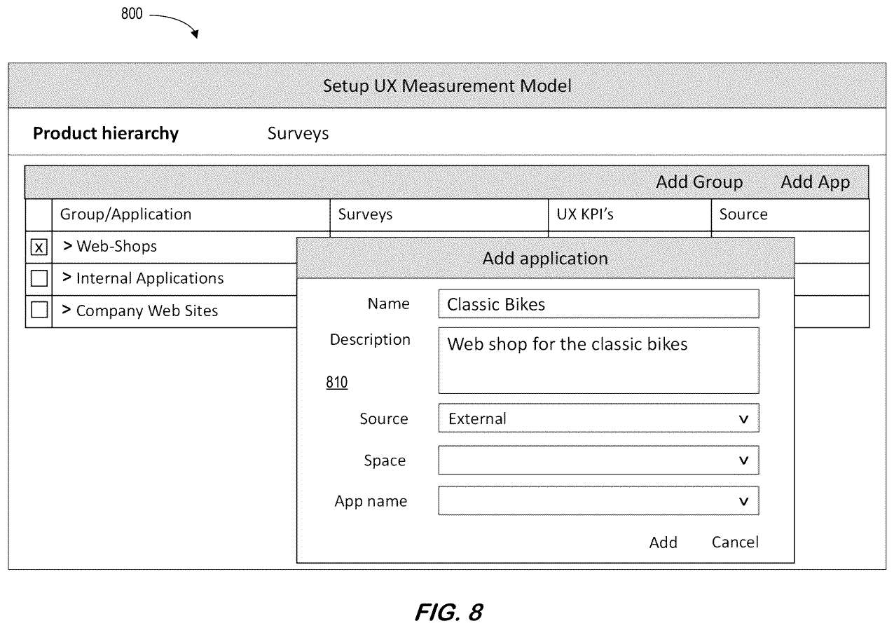

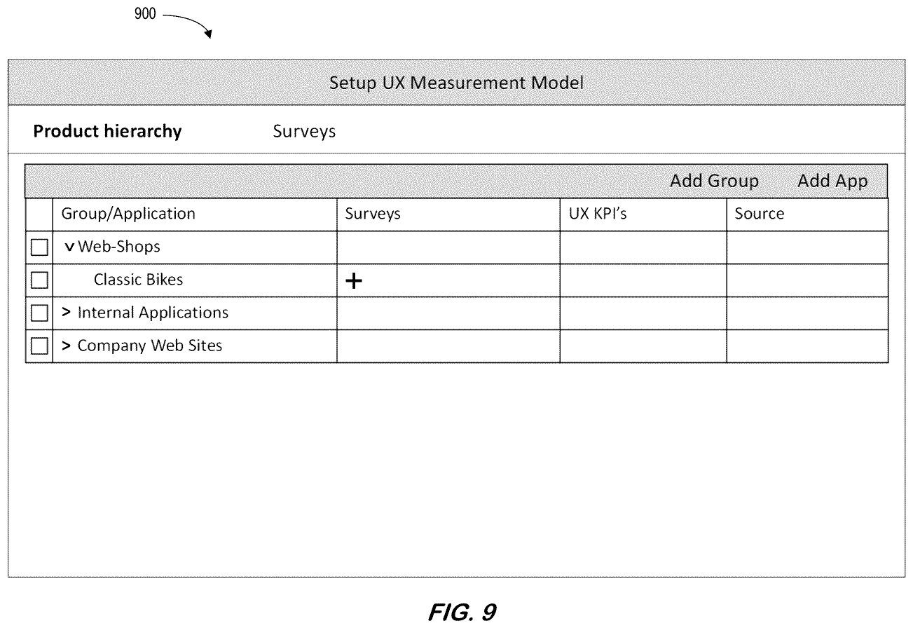

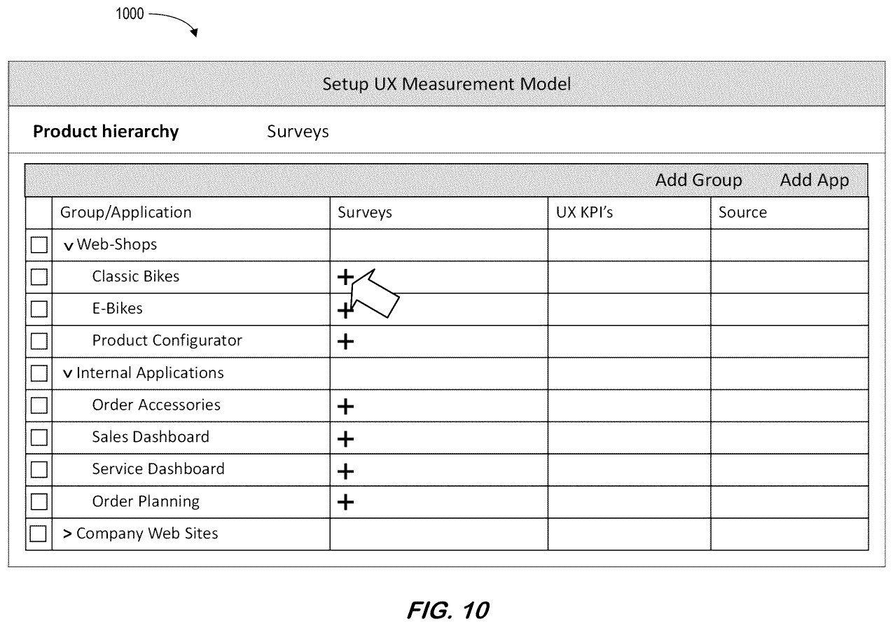

Selection of an “Add App” icon on the interface 700 results in an interface 800 with an add application data entry area 810 (as shown in FIG. 8) that may be used to provide an application name, an application description, source, etc. When an “Add” icon is selected, a table is updated with the new application (“Classic Bikes”) as in the table shown in the example interface 900 of FIG. 9. Note that “Classic Bikes” appears under the “Web-Shops” node in the hierarchy defined by the table. FIG. 10 shows an interface 1000 with a table that has been fully populated for CoolBikes.

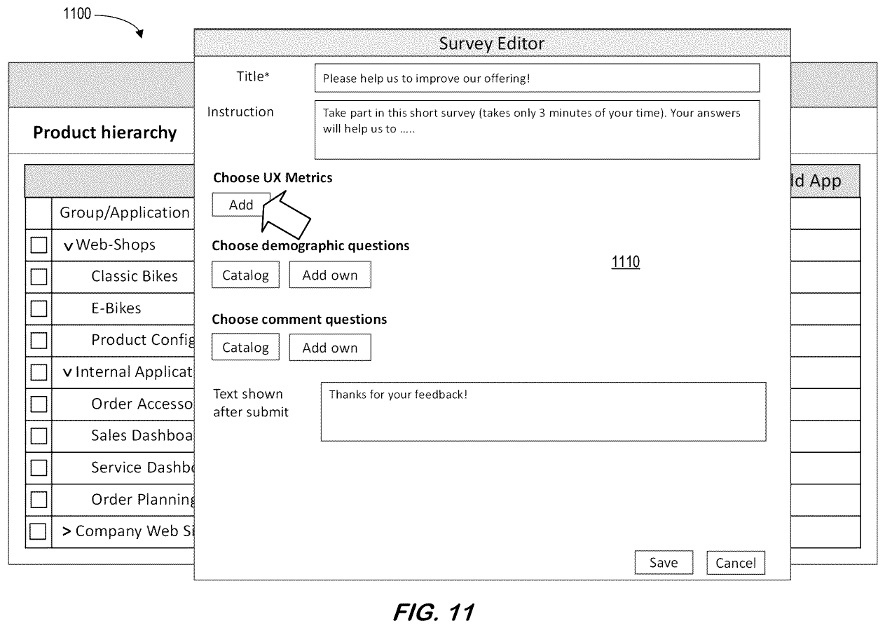

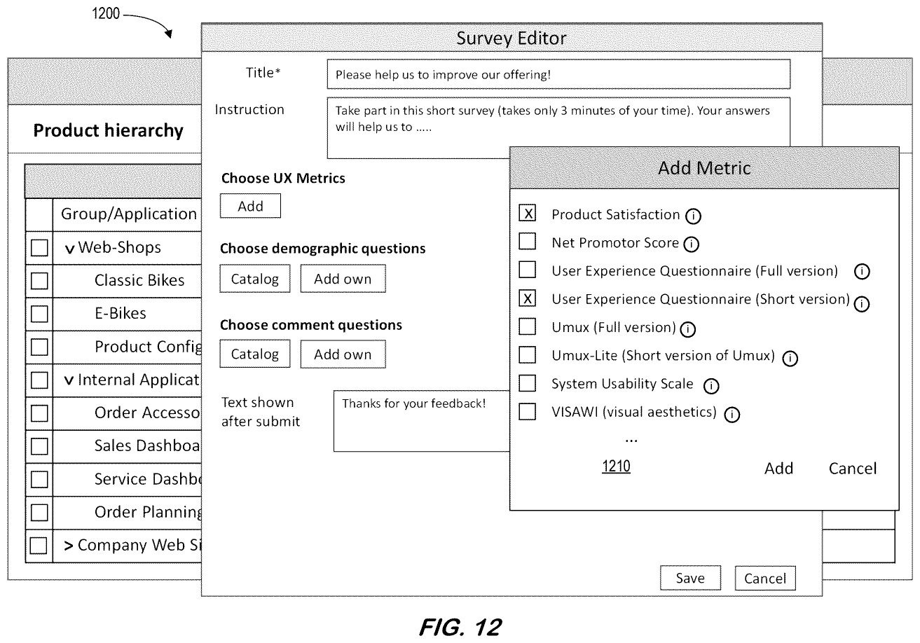

Selection of a “Surveys” icon for “Classic Bikes” results in an interface 1100 with a “Survey Editor” data entry area 1110 (as shown in FIG. 11) that may be used to define a survey title, survey instructions, user experience metrics, demographic information, comment questions, etc. As used herein, the term “metrics” may refer to a set of questions (e.g., rating scales) and a rule to compute a score from the answers. Some embodiments may additionally add visualization choices (line chart, bar chart, etc.) for later use when a dashboard is generated. According to some embodiments, the survey editor may allow for predefined content and/or the possibility to define enterprise specific fields. In some embodiments, a list of existing “standard” user interface experience questionnaires is available. Selection of an “Add” user experience metrics icon results in an interface 1200 with an add metric data entry area 1210 (as shown in FIG. 12) that can be used to select one or more predefined questionnaires associated with, for example, product satisfaction, a Net Promotor Score (“NPS”), visual aesthetics, etc.

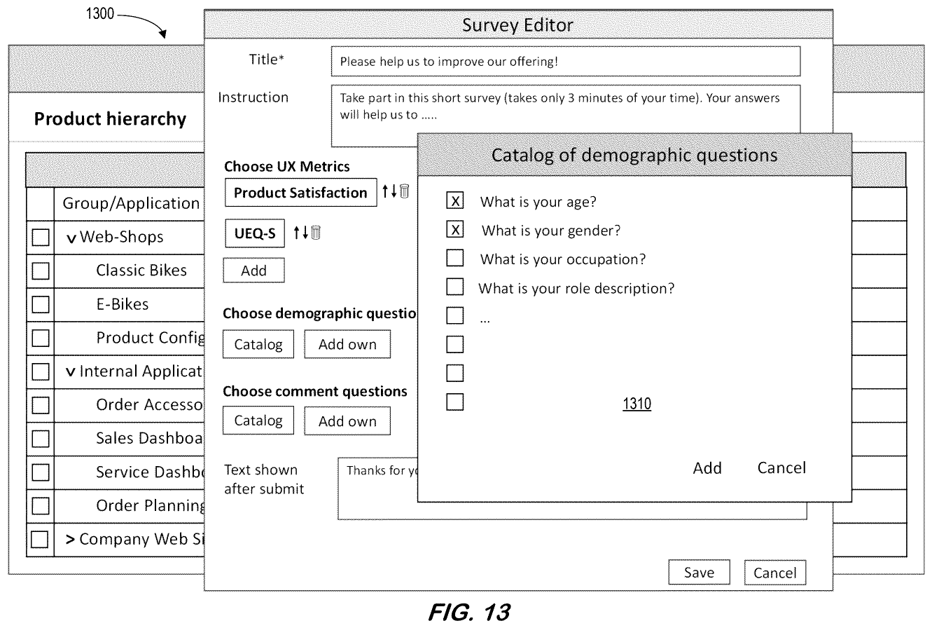

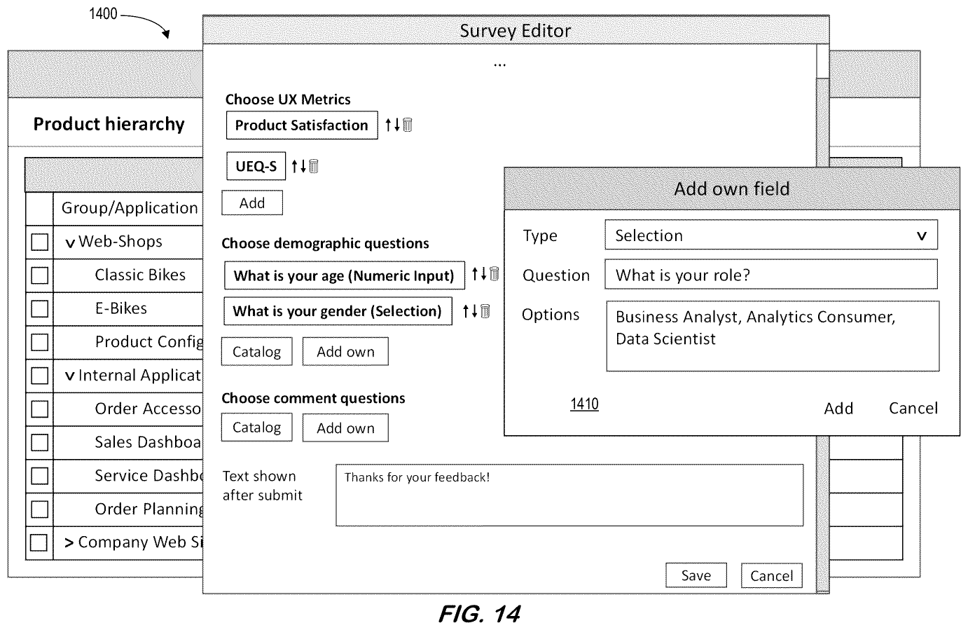

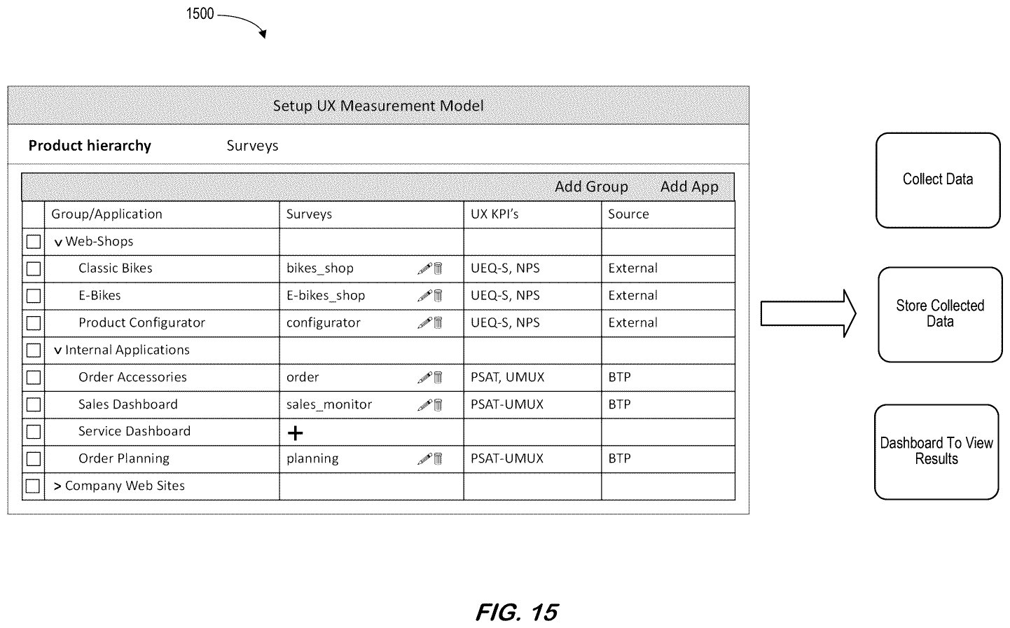

Referring again to FIG. 11, selection of a “Catalog” demographic question icon results in an interface 1300 with a “Catalog of Demographic Questions” data entry area 1310 (as shown in FIG. 13) that may be used to select existing questions such as “what is your age?”, “what is your gender”, etc. Referring again to FIG. 11, selection of an “Add Own” demographic question icon results in an interface 1400 with an “Add Own Field” data entry area 1410 (as shown in FIG. 14) that may be used to define a demographic question type, question text, survey answer options (if applicable), etc. FIG. 15 shows an interface 1500 with a fully populated hierarchy table with surveys to the nodes. The service may then automatically collect data (using artifacts and/or HTML-page plus storage logic), store the collected data in an infrastructure (e.g., one table per survey plus some infrastructure to aggregate), and utilize a dashboard to provide survey results to the enterprise. According to some embodiments, survey links may be automatically generated which are then manually added to the applications themselves. In some embodiments, a URL is generated for each survey. This URL is handed over to developers to enable the survey in external applications (web sites, etc.). Moreover, surveys may be automatically translated into other languages.

According to some embodiments, an enterprise can define how data of the applications below a product node should be aggregated. Several aggregation schemes may help to answer different questions, and thus a choice may be provided to match the special use case of an enterprise. For example, results might be aggregated on the basis of single answers. That is, all survey responses for products below a node will be used and weighted equally to calculate an aggregated KPI. This may show the overall impression of all users of a certain application area represented by a node in the product hierarchy. As another example, results may be aggregated on the basis of applications. That is, the KPI may be calculated for each application in a node. Then the KPIs below a node may be aggregated (unweighted). This may show the overall user experience quality of applications that belong to a part of the organization represented by a node. As still another example, weighted aggregation may be performed. That is, a weight can be assigned to each application. Then the KPIs for the applications below a node are aggregated according to the weights. This may help an enterprise understand the importance or business value of applications. In some embodiments, the aggregation schema may be the same for all nodes in a hierarchy, but it is also possible to define this feature on a per-node basis.

To support the interpretation of KPI changes over time, classical statistical methods may be used. For example, confidence intervals may be created and/or significance tests may be applied. These values might be, for example, automatically calculated based on the aggregation method (the concrete statistical procedures may depend on the method). The KPIs, confidence intervals, significance indicators, etc. may be displayed automatically in a dashboard display.

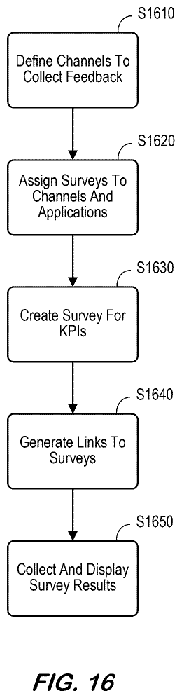

FIG. 16 is a user survey tool method in accordance with some embodiments.

At S1610, survey channels that should be used to collect feedback are defined. For example, a survey might be associated with “in product” feedback, an e-mail campaign, a social media campaign, etc. At S1620, a survey is associated to each channel and application. For example, an enterprise may select the user experience metrics they want to use per channel and product. The framework may offer several preconfigured established metrics (e.g., PSAT, NPS, UMUX, SUS, UEQ, etc.). In some embodiments, an enterprise may enhance metrics with enterprise-specific questions, such as a comment field for “What should be improved?” or a demographic questions, such as “What is your age?” The framework may already contain several typical additional questions that can simply be selected. It may also be possible for an enterprise to define new questions (e.g., via text fields, selection fields, checkbox groups, radio-button groups, etc.) and also new customer specific metrics.

At S1630, KPIs and questions may be created when a survey is generated automatically. In some embodiments, a survey may be built in an external survey tool. In that case, a method to import the survey data (e.g., an EXCEL® Extensions (“XLSX”) file or Comma Separated Values (“CSV”) file) may be provided and a mapping to the structure may be defined. At S1640, a link may be generated or determined if an external survey tool is used. This link can be used to post the survey in e-mail campaigns or on social media channels. In addition, the link might be placed in a feedback button within an application. At S1650, data can be collected and displayed in a dashboard. For the display, it can be decided (based on the volume of data for that enterprise) whether the KPI changes are visualized on a weekly basis, monthly basis, quarterly basis, etc.

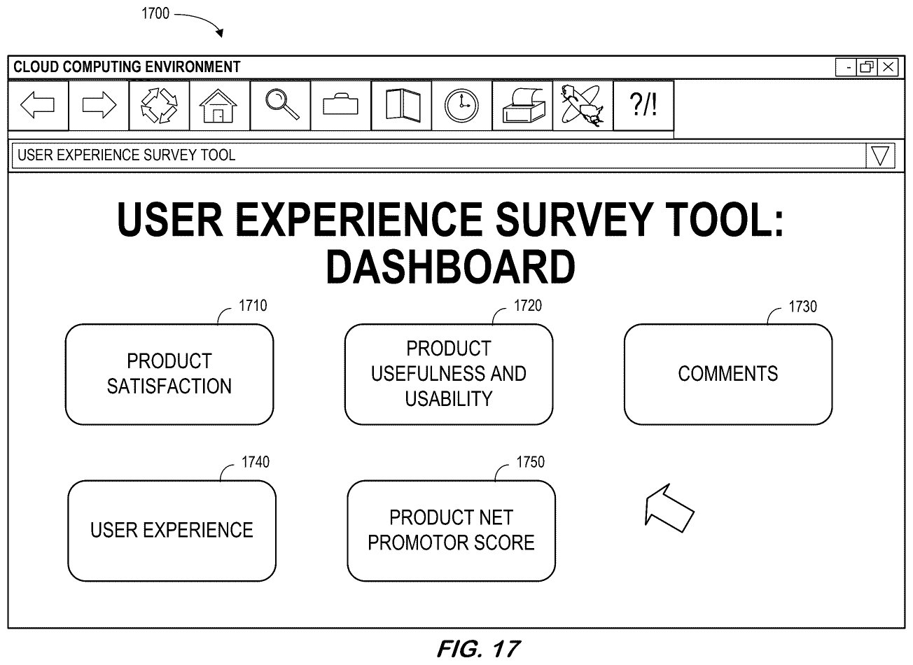

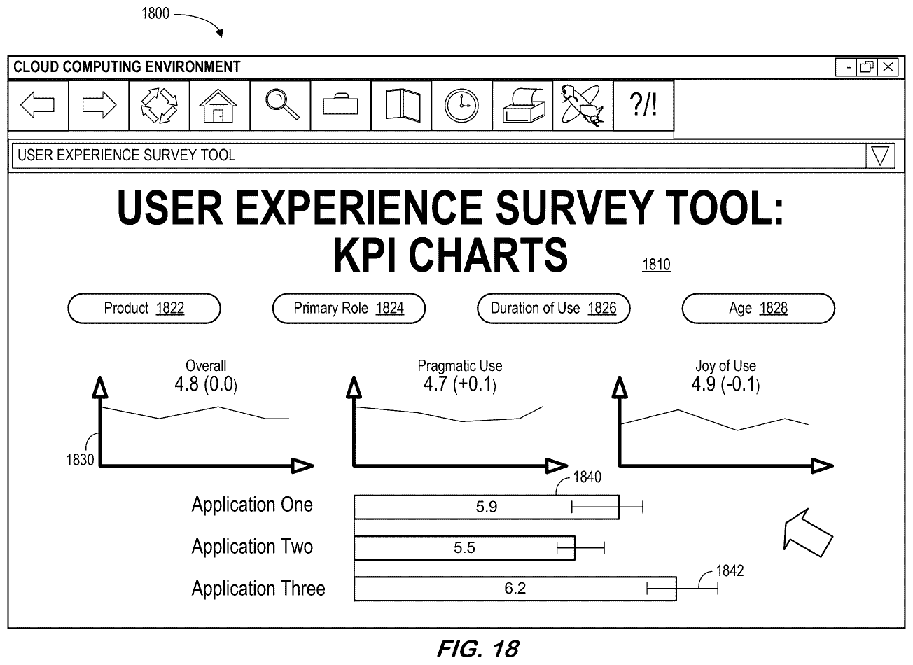

FIG. 17 is a user survey tool dashboard display 1700 according to some embodiments. The display 1700 might represent a survey tool entry screen and may include, for example, a “Product Satisfaction” icon 1710, a “Product Usefulness and Usability” icon 1720, a “Comments” icon 1730, a “User Experience” icon 1740, a “Product Net Promotor Score” icon 1750, etc. FIG. 18 is a user survey tool KPI display 1800 in accordance with some embodiments. The KPI display 1800 includes a KPI dashboard 1810 with product hierarchy filters that can be used to drill into survey results, such as a “Product” filter 1822, a “Primary Role” filter 1824, a “Duration of Use” filter 1826, an “Age” filter 1828, etc. The main area includes charts 1830 that show the standardized reporting of the metrics including references to external benchmarks. Additional data could be shown in dialogs when an enterprise hovers over some elements (e.g., as bar graphs 1840 and confidence ranges 1842).

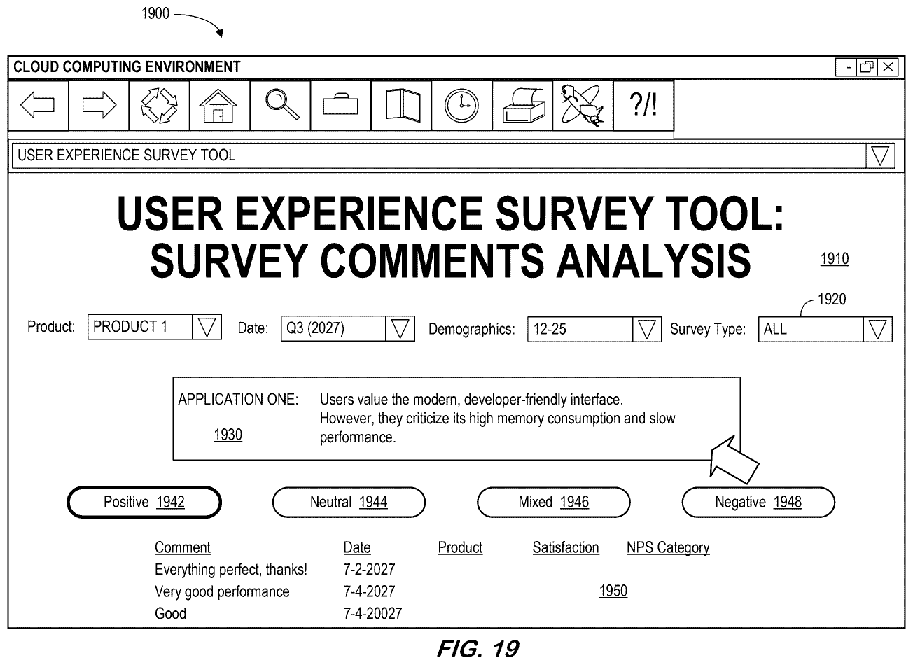

FIG. 19 is a user survey tool comments analysis display 1900 according to some embodiments. The display 1900 includes an automatically generated analysis 1910 filtered by selection 1920 for product, date, demographics, survey type, etc. A summary 1930 may be generated with an artificial intelligence algorithm (e.g., via a Large Language Model (“LLM”) or other Machine Learning (“ML”) technique). Individual comments 1950 (e.g., entered using a free text field in a survey) can be viewed by applying a “Positive” filter 1942, a “Neutral” filter 1944, a “Mixed” filter 1946, a “Negative” filter 1948, etc.

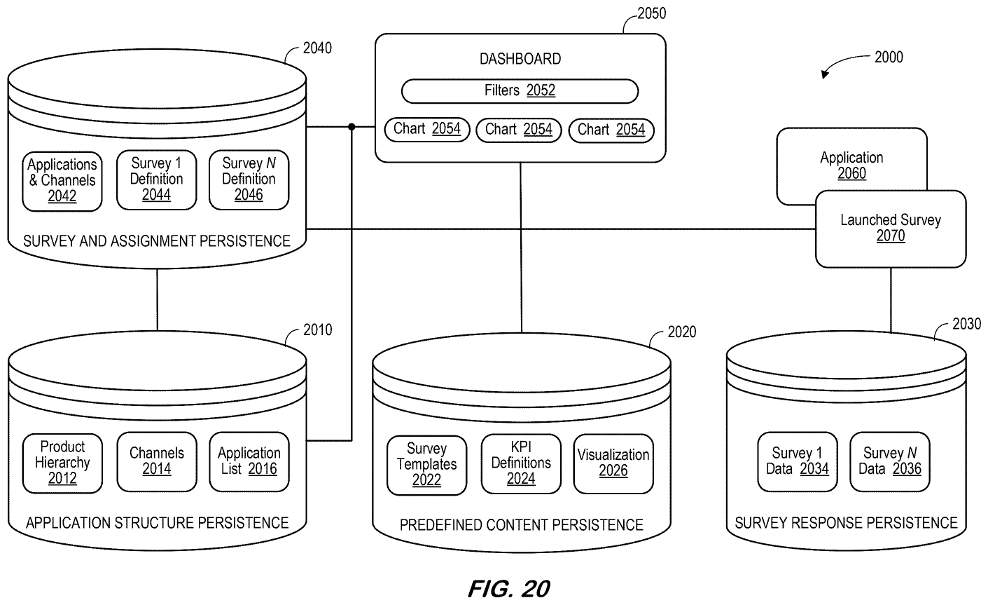

FIG. 20 is a user survey tool architecture 2000 in accordance with some embodiments. An application structure persistence 2010 (e.g., defined by enterprise) may include a product hierarchy 2012, channels 2014, and an application list 2016. A predefined content persistence 2020 may include survey templates 2022, KPI definitions 2024, and KPI visualizations 2026. A survey response persistence 2030 may include survey 1 data 2034 through survey N data 2036 (e.g., as stored by an application 2060 and a launched survey 2070). A survey and assignment persistence 2040 (e.g., defined by enterprise) may include an assignment of surveys to application and channels 2042 and survey 1 definition 2044 through survey N definition 2046. The survey and assignment persistence 2040 may receive information from the application structure persistence 2010 and the predefined content persistence 2020. A dashboard 2050 may read an application list and product hierarchy from the application structure persistence 2010 and the survey and assignment persistence 2040 to control filters 2052. The dashboard 2050 may also read rules and definitions from the predefined content persistence 2020 to calculate a KPI and determine how it should be displayed. The dashboard 2050 may also read data required for the display to generate charts 2054.

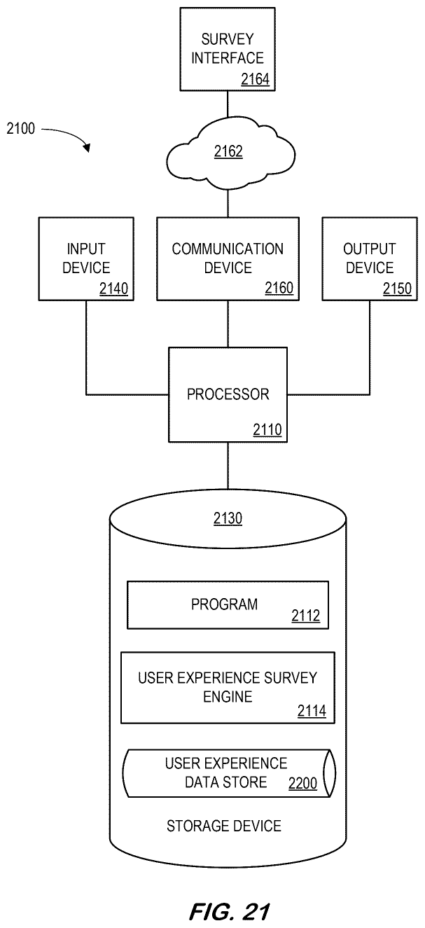

Note that the embodiments described herein may be implemented using any number of different hardware configurations. For example, FIG. 21 is a block diagram of an apparatus or platform 2100 that may be, for example, associated with the system 100 of FIG. 1 (and/or any other system described herein). The platform 2100 comprises a processor 2110, such as one or more commercially available Central Processing Units (“CPUs”) in the form of one-chip microprocessors, coupled to a communication device 2160 configured to communicate via a communication network 2162. The communication device 2160 may be used to communicate, for example, with one or more survey interfaces 2164 via a distributed computer network 2162. The platform 2100 further includes an input device 2140 (e.g., a computer mouse and/or keyboard to input product hierarchy information, aggregation rules, etc.) and/an output device 2150 (e.g., a computer monitor to render a display, transmit recommendations, charts, alerts, and/or reports about user experience survey results, etc.).

The processor 2110 also communicates with a storage device 2130. The storage device 2130 may comprise any appropriate information storage device, including combinations of magnetic storage devices (e.g., a hard disk drive), optical storage devices, mobile telephones, and/or semiconductor memory devices. The storage device 2130 stores a program 2112 and/or user experience survey engine 2114 for controlling the processor 2110. The processor 2110 performs instructions of the programs 2112, 2114, and thereby operates in accordance with any of the embodiments described herein. For example, the processor 2110 may receive from an enterprise an adjustment to the hierarchy of product nodes and store an adjusted hierarchy of product nodes. The processor 2110 may then retrieve user experience survey results for a plurality of user applications. The retrieved user experience survey results may be automatically aggregated by the processor 2110 in accordance with the adjusted enterprise product hierarchy and an aggregation rule selected by the enterprise. An indication of the aggregated user experience survey results may then be output to the enterprise.

The programs 2112, 2114 may be stored in a compressed, uncompiled and/or encrypted format. The programs 2112, 2114 may furthermore include other program elements, such as an operating system, clipboard application, a database management system, and/or device drivers used by the processor 2110 to interface with peripheral devices.

As used herein, information may be “received” by or “transmitted” to, for example: (i) the platform 2100 from another device; or (ii) a software application or module within the platform 2100 from another software application, module, or any other source.

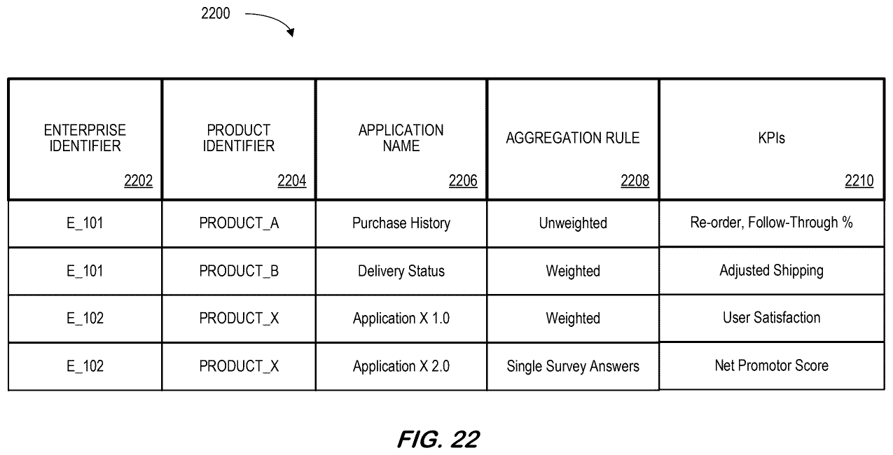

In some embodiments (such as the one shown in FIG. 21), the storage device 2130 further stores user experience data store 2200. An example of a database that may be used in connection with the platform 2100 will now be described in detail with respect to FIG. 22. Note that the database described herein is only one example, and additional and/or different information may be stored therein. Moreover, various databases might be split or combined in accordance with any of the embodiments described herein.

Referring to FIG. 22, a table is shown that represents the user experience data store 2200 that may be stored at the platform 2100 according to some embodiments. The table may include, for example, entries identifying survey results collected by a user experience survey framework for an enterprise. The table may also define fields 2202, 2204, 2206, 2208, 2210 for each of the entries. The fields 2202, 2204, 2206, 2208, 2210 may, according to some embodiments, specify: an enterprise identifier 2202, a product identifier 2204, an application name 2206, an aggregation rule 2208, and KPIs 2210. The user experience data store 2200 may be created and updated, for example, when a new product or application is added, survey results are received, etc.

The enterprise identifier 2202 might be a unique alphanumeric label that is associated with a particular business or company that is conducting a user experience survey. The product identifier 2204 and the application name 2206 may be associated with a product hierarchy defined for the enterprise. The aggregation rule 2208 might indicate that survey results should be processed via unweighted aggregation, weighted aggregation, aggregation based on single survey answers, etc. The KPIs 2210 may be values computed based on the aggregated survey results and may be used to generate charts for a dashboard display.

In this way, embodiments may offer an efficient way to set up a clear and state-of-the-art user experience measurement process with little effort. This may be facilitated using a clear conceptual model of such a process. The process is flexible enough to be adapted to the needs of companies (e.g., selecting the right user experience metrics for applications, selecting the appropriate channels, aggregating results from different surveys, showing the results in a state-of-the-art dashboard that makes the analysis and interpretation easy to understand, etc.).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

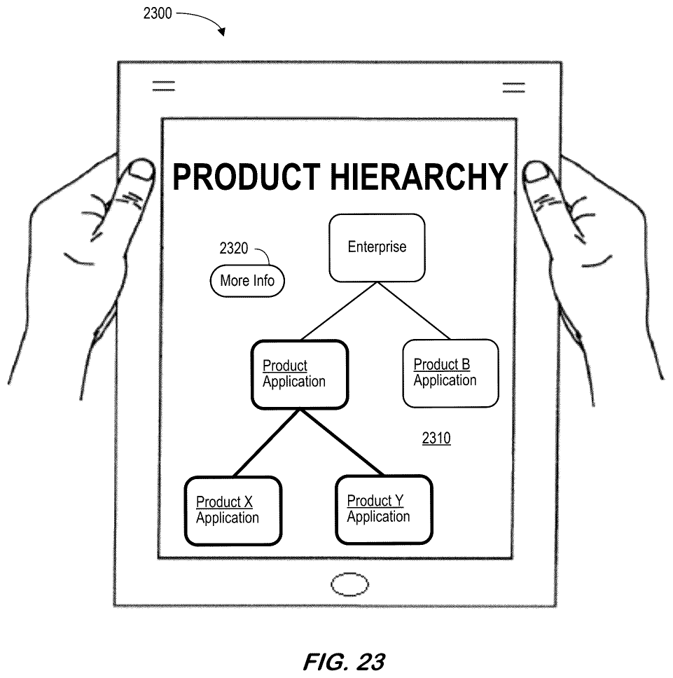

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of KPI values and applications, any of the embodiments described herein could be applied to other types of KPI values and applications. Moreover, the displays shown herein are provided only as examples, and any other type of user interface could be implemented. For example, FIG. 23 illustrates a tablet computer 2300 providing product hierarchy information 2310 for a user experience survey tool. The product hierarchy information 2310 might be used, for example, to view and/or modify aspects of survey result analysis via selection of a “More Info” icon 2320.

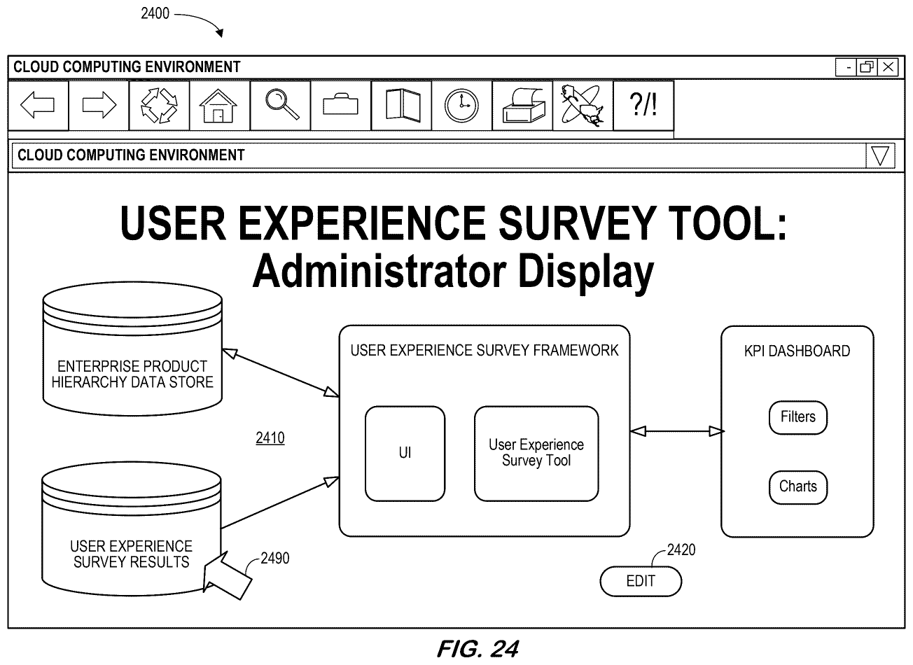

FIG. 24 is an operator or administrator display in accordance with some embodiments. The display 2400 includes a graphical representation 2410 of a user experience survey tool in accordance with any of the embodiments described herein. Selection of an element on the display 2400 (e.g., via a touchscreen or computer pointer 2490) may result in display of a pop-up window containing more detailed information about that element and/or various options (e.g., to define how a user experience survey tool interacts with a user experience survey framework for an enterprise, etc.). Selection of an “Edit” icon 2420 may also let an operator or administrator adjust the operation of the system (e.g., to change mapping to a data store, adjust a list of applications and survey channels, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system associated with a user experience survey framework for an enterprise, comprising:
an enterprise product hierarchy data store that contains information about a hierarchy of product nodes, each product node being associated with a user application; and
a user experience survey tool, coupled to the enterprise product hierarchy data store, including:
a computer processor, and
a computer memory storing instructions that when executed by the computer processor cause the user experience survey tool to:
receive from the enterprise an adjustment to the hierarchy of product nodes,
store an adjusted hierarchy of product nodes into the enterprise product hierarchy data store,
retrieve user experience survey results for a plurality of user applications,
automatically aggregate the retrieved user experience survey results in accordance with the adjusted enterprise product hierarchy and an aggregation rule selected by the enterprise, and
output to the enterprise an indication of the aggregated user experience survey results.

2. The system of claim 1, wherein the automatic aggregation is performed on the basis of single user experience survey answers.

3. The system of claim 1, wherein the automatic aggregation is performed on the basis of unweighted user experience survey results for all user applications below a particular node.

4. The system of claim 1, wherein the automatic aggregation is performed on the basis of weighted user experience survey results for all user applications below a particular node.

5. The system of claim 1, wherein the retrieved user experience survey results are associated with at least one of: (i) an existing standard user experience survey contained as a template, (ii) Customer Satisfaction (“CSAT”) data, (iii) Net Promoter Score (“NPS”) data, (iv) Usability Metric for User Experience (“UMUX”) data, (v) System Usability Scale (“SUS”) data, (vi) User Experience Questionnaire (“UEQ”) data, (vii) a customer defined survey, (viii) demographic information, (ix) a user role, and (x) a length of application use.

6. The system of claim 1, wherein the retrieved user experience survey results are associated with multiple channels, including at least one of: (i) a product feedback channel, (ii) an e-mail campaign channel, and (iii) a social media campaign channel.

7. The system of claim 1, wherein the indication of the aggregated user experience survey results output to the enterprise includes at least one of: (i) Key Performance Indicators (“KPIs”), (ii) confidence intervals, and (iii) significance indicators.

8. The system of claim 1, wherein the user experience survey tool is further to perform at least one of: (i) automatically generate a user survey from a template library, and (ii) receive a user experience survey defined by the enterprise.

9. The system of claim 1, wherein the user experience survey tool is further to automatically generate a user experience survey link.

10. The system of claim 1, wherein the user experience survey tool is further to automatically analyze open-ended user experience survey results using Artificial Intelligence (“AI”) algorithms to create a summary.

11. The system of claim 1, wherein the user experience survey tool is to interact with multiple enterprises.

12. A computer-implemented method associated with a user experience survey framework for an enterprise, comprising:
receiving, by a computer processor of a user experience survey tool from the enterprise, an adjustment to a hierarchy of product nodes;
storing an adjusted hierarchy of product nodes into an enterprise product hierarchy data store, wherein the enterprise product hierarchy data store contains information about the hierarchy of product nodes, each product node being associated with a user application;
retrieving user experience survey results for a plurality of user applications;
automatically aggregating the retrieved user experience survey results in accordance with the adjusted enterprise product hierarchy and an aggregation rule selected by the enterprise; and
outputting to the enterprise an indication of the aggregated user experience survey results.

13. The method of claim 12, wherein the automatic aggregation is performed on the basis of single user experience survey answers.

14. The method of claim 12, wherein the automatic aggregation is performed on the basis of unweighted user experience survey results for all user applications below a particular node.

15. The method of claim 12, wherein the automatic aggregation is performed on the basis of weighted user experience survey results for all user applications below a particular node.

16. The method of claim 12, wherein the retrieved user experience survey results are associated with at least one of: (i) an existing standard user experience survey contained as a template, (ii) Customer Satisfaction (“CSAT”) data, (iii) Net Promoter Score (“NPS”) data, (iv) Usability Metric for User Experience (“UMUX”) data, (v) System Usability Scale (“SUS”) data, (vi) User Experience Questionnaire (“UEQ”) data, (vii) customer defined a customer defined survey, (viii) demographic information, (ix) a user role, and (x) a length of application use.

17. The method of claim 12, wherein the retrieved user experience survey results are associated with multiple channels, including at least one of: (i) a product feedback channel, (ii) an e-mail campaign channel, and (iii) a social media campaign channel.

18. The method of claim 12, wherein the indication of the aggregated user experience survey results output to the enterprise includes at least one of: (i) Key Performance Indicators (“KPIs”), (ii) confidence intervals, and (iii) significance indicators.

19. A non-transitory, machine-readable medium comprising instructions thereon that, when executed by a processor, cause the processor to execute operations to perform a method associated with a user experience survey framework for an enterprise, the method comprising:
receiving, by a computer processor of a user experience survey tool from the enterprise, an adjustment to a hierarchy of product nodes;
storing an adjusted hierarchy of product nodes into an enterprise product hierarchy data store, wherein the enterprise product hierarchy data store contains information about the hierarchy of product nodes, each product node being associated with a user application;
retrieving user experience survey results for a plurality of user applications;
automatically aggregating the retrieved user experience survey results in accordance with the adjusted enterprise product hierarchy and an aggregation rule selected by the enterprise; and
outputting to the enterprise an indication of the aggregated user experience survey results.

20. The medium of claim 19, wherein the user experience survey tool is further to perform at least one of: (i) automatically generate a user survey from a template library, and (ii) receive a user experience survey defined by the enterprise.

21. The medium of claim 19, wherein the user experience survey tool interacts with multiple enterprises and is further to automatically generate a user experience survey link and analyze open-ended user experience survey results using Artificial Intelligence (“AI”) algorithms to create a summary.
